(19) United States
(12) Patent Application Publication
(10) Pub. No.: US 2018/0164944 A1
(43) Pub. Date: Jun. 14, 2018

(54) SENSOR-EQUIPPED DISPLAY DEVICE, CONTROL DEVICE, AND CONTROL METHOD

(71) Applicant: SHARP KABUSHIKI KAISHA, Sakai City, Osaka (JP)

(72) Inventors: MASASHI MAYUMI, Sakai City (JP); DAIJI KITAGAWA, Sakai City (JP)

(21) Appl. No.: 15/577,879

(22) PCT Filed: May 27, 2016
(86) PCT No.: PCT/JP2016/065744

§ 371 Date: Nov. 29, 2017

(30) Foreign Application Priority Data
May 29, 2015 (JP) 2015-109998

(51) Int. Cl. G06F 3/041; G09G 3/36

(52) U.S. Cl. CPC G06F 3/0416; G09G 3/3666; G09G 2320/0219; G06F 3/0412; G09G 2310/02; G09G 3/3677

(57) ABSTRACT

A sensor-equipped display device (1) includes driving lines (DRL) arrayed in a first direction in an area that overlaps the screen; detection lines (SNL) arrayed in a second direction in the area that overlaps the screen; and a detection control unit (30) that outputs driving signals each of which includes a plurality of pulses, to the driving lines, respectively, and detects signals of the detection lines in correspondence to the diving signals. The detection control unit (30) outputs driving signals each of which includes a plurality of pulses, simultaneously to 2N driving lines (N is a natural number) that are sequentially arrayed in the first direction. Rising of the pulses of the driving signals for the N driving lines out of the 2N driving lines, and falling of the pulses of the driving signals for the other N driving lines, occur at the same time.

### TECHNICAL FIELD

The disclosure of the present application relates to a sensor-equipped display device that includes a screen that displays an image, and a sensor that detects contact or approach of an object with respect to the screen.

### BACKGROUND ART

In recent years, a sensor-equipped display device that includes a display unit including a screen that displays an image, and a touch panel that detects contact or approach of an object such as a finger or a pen with respect to the screen has been commercialized. In the sensor-equipped display device, driving signals for the display unit can be noise and exert influences on the touch panel. Besides, the driving signals for the touch panel also can be noise for the display unit. The display unit and the touch panel can interfere with each other in this way, which causes the respective signal-noise (SN) ratios to decrease, resulting in that malfunctions occur, or the detection accuracy or the display quality deteriorate, in some cases.

In order to suppress the interference between the display unit and the touch panel, the controlling is performed with the driving timing of the display unit and the driving timing of the touch panel being associated with each other. For example, in the display device having a touch detection function disclosed in Patent Document 1 indicated below, the display elements are driven in such a manner that M horizontal lines are sequentially displayed in each of a plurality of unit driving periods that compose one frame period. Further, touch detection elements are driven during N touch detection periods provided in the unit driving period, N being smaller than M.

In this way, one frame period is divided into a period for display and a period for detection on the touch panel, and the driving for display and the driving for detection are executed sequentially, whereby interference with each other can be suppressed.

### PRIOR ART DOCUMENT

### Patent Document

Patent Document 1: JP-A-2013-84168

### SUMMARY OF THE INVENTION

### Problem to be Solved by the Invention

If the resolution of the display unit is increased, a period required for driving the display unit increases. If the time required for driving the display unit increases, the period that can be assigned for the touch panel decreases, which makes it difficult to balance the driving of the display unit and the driving of the touch panel well. Besides, if a sufficient period for driving the touch panel cannot be ensured, this can deter the performance of the touch panel from improving.

In order to ensure time for the driving of the touch panel, the driving of the touch panel may be allowed while the display unit is being driven. In such a case, it is preferable to prevent the diving signal of the touch panel from serving as a noise thereby adversely affecting the image display by the display unit.

The present application discloses a sensor-equipped display device, a control device, and a control method that are capable of suppressing influence on image display exerted by an object detecting operation with respect to a screen that displays an image.

### Means to Solve the Problem

A sensor-equipped display device in one embodiment of the present invention includes a screen that display an image, and a sensor that detects contact or approach of an object with respect to the screen. The sensor-equipped display device includes: a plurality of driving lines arrayed in a first direction in an area that overlaps the screen; a plurality of detection lines arrayed in a second direction in the area that overlaps the screen; and a detection control unit that outputs driving signals each of which includes a plurality of pulses, to the driving lines, respectively, and detects signals of the detection lines in correspondence to the diving signals. The detection control unit outputs driving signals each of which includes a plurality of pulses, simultaneously to 2N driving lines (N is a natural number) that are sequentially arrayed in the first direction. Rising of the pulses of the driving signals for the N driving lines out of the 2N driving lines, and falling of the pulses of the driving signals for the other N driving lines, occur at the same time.

### Effect of the Invention

According to the disclosure of the present application, it is possible to suppress influence on display of an image exerted by an object detecting operation with respect to a screen that displays an image.

### BRIEF DESCRIPTION OF DRAWINGS

FIG. 1 is a block diagram illustrating an exemplary configuration of a sensor-equipped display device.

FIG. 2 is a cross-sectional view illustrating the exemplary configuration of the sensor-equipped display device illustrated in FIG. 1.

FIG. 3 is a perspective view illustrating an exemplary laminate configuration of drive lines, detection lines, gate lines G, and data lines.

FIG. 4 illustrates exemplary waveforms of driving signals.

FIG. 5 illustrates exemplary noises generated by the driving signals illustrated in FIG. 4.

FIG. 6 illustrates an image of a waveform obtained when noises of the driving signals are superimposed.

FIG. 7 illustrates an exemplary modification of a common electrode.

FIG. 8 illustrates an exemplary modification of the driving signals.

FIG. 9 illustrates another exemplary modification of the driving signals.

### MODE FOR CARRYING OUT THE INVENTION

A sensor-equipped display device in one embodiment of the present invention includes a screen that display an image, and a sensor that detects contact or approach of an object with respect to the screen. The sensor-equipped display device includes: a plurality of driving lines arrayed in a first direction in an area that overlaps the screen; a plurality of detection lines arrayed in a second direction in the area that overlaps the screen; and a detection control unit that outputs driving signals each of which includes a plurality of pulses, to the driving lines, respectively, and detects signals of the detection lines in correspondence to the diving signals. The detection control unit outputs driving signals each of which includes a plurality of pulses, simultaneously to 2N driving lines (N is a natural number) that are sequentially arrayed in the first direction. Rising of the pulses of the driving signals for the N driving lines out of the 2N driving lines, and falling of the pulses of the driving signals for the other N driving lines, occur at the same time.

According to the above-described configuration, the rising of the pulses of the driving signals for the N driving lines out of the 2N driving lines that are sequentially arrayed, and the falling of the pulses of the driving signals for the other N driving lines, occur at the same time. With this configuration, the noise caused by the driving signals for the N driving lines and the noise caused by the driving signals for the other N driving lines cancel each other. The noise caused by the driving signals for the 2N driving lines is reduced. As a result, influence on the display on the screen, exerted by driving signals, can be suppressed.

The above-described sensor-equipped display device may further include: scanning lines arrayed in one of the first direction and the second direction in the area that overlaps the screen; data lines arrayed in the other one of the first direction and the second direction in the area that overlaps the screen; a plurality of switching elements provided in correspondence to points of intersection between the scanning lines and the data lines, respectively; a plurality of pixel electrodes connected to the switching elements, respectively; and a common electrode opposed to the pixel electrodes and the driving lines. A portion of the common electrode opposed to the group of the 2N driving lines, to which the driving signals are output simultaneously, can be arranged so as to be separated from a portion thereof opposed to the other driving lines.

According to the above-described configuration, the portion of the common electrode opposed to the group of the 2N driving lines are arranged so as to be separated from the other portion of the common electrode. Noise caused by the group of 2N driving lines, therefore, is prevented from adversely affecting an entirety of the common electrode. This enables to further suppress the influence on the screen display exerted by the driving signals.

The driving lines may include a plurality of groups each of which includes 2N driving lines to which the driving signals are output simultaneously. In this case, the diving signals can be output sequentially to the groups each of which includes 2N driving lines. This enables sequentially driving in a state in which noise caused by driving signals is suppressed.

The common electrode may include a plurality of electrode portions that are respectively opposed to the groups each of which includes 2N driving lines. In this case, the electrode portions can be arranged so as to be separated from one another. This allows the sequentially driving to be performed in a state in which noise caused by the group of the 2N driving lines is prevented from influencing the entirety of the common electrode. This makes it possible to further suppress influence on the screen display caused by the driving signals.

The sensor-equipped display device can further include a first substrate on which the scanning lines, the data lines, the switching elements, and the pixel electrodes are arranged, and a second substrate provided so as to be opposed to the first substrate. In this case, the driving lines and the detection lines can be arranged on at least one of the first substrate and the second substrate. This allows the display unit and the sensor to be integrally formed with use of the first substrate and the second substrate. In a case where the display unit and the sensor are integrally provided in this way, the driving lines and the detection lines for detecting an object, and elements for displaying images, that is, the data lines, the scanning lines, the switching elements, the pixel electrodes, and the common electrode, can be arranged at positions close to each other. This causes the driving signals to tend to exert influence on the screen display. The above-described configuration, with which influence of noise caused by the driving signals can be suppressed, achieves effects particularly in a case in which the display unit and the sensor are integrally provided.

The sensor-equipped display device can further include the scanning lines, the data lines, the switching elements, the pixel electrodes, a scanning driving unit, and a data driving unit. The scanning driving unit repeats a screen scanning operation with respect to the scanning lines, the screen scanning operation with respect to the scanning lines being an operation of selecting the scanning lines sequentially in the first direction throughout the screen. The data driving unit outputs a signal to the data lines in synchronization with the scanning of the scanning lines by the scanning driving unit, thereby applying, to the pixel electrodes, voltages corresponding to gray levels to be displayed, respectively. In this case, the detection control unit performs the screen scanning operation with respect to the driving lines, during at least a part of time while the screen scanning operation with respect to the scanning lines is performed.

According to the above-described configuration, the screen scanning operation with respect to the driving lines and the screen scanning operation with respect to the scanning lines can be performed simultaneously. This makes it easier to ensure both of sufficient time for the operation for screen display, and sufficient time for the operation for detecting an object. Further, the above-described configuration makes it possible to suppress noise due to the driving signals. Accordingly, even in a case where the screen scanning operation with respect to the driving lines and the screen scanning operation with respect to the scanning lines are performed simultaneously, influence on screen display exerted by the driving signals is suppressed.

A control method in an embodiment of the present invention relates to a method for controlling electronic equipment that includes a screen that displays an image, a plurality of driving lines arrayed in a first direction in an area that overlaps the screen, and a plurality of detection lines arrayed in a second direction in the area that overlaps the screen. The control method includes: a driving step of outputting driving signals each of which includes a plurality of pulses, to the driving lines, respectively; and a detecting step of detecting signals of the detection lines in correspondence to the diving signals. In the driving step, driving signals each of which includes a plurality of pulses are output simultaneously to a group of 2N driving lines (N is a natural number) that are sequentially arrayed in the first direction. Rising of the pulses of the driving signals for the N driving lines of the group of the 2N driving lines, and falling of the pulses of the driving signals for the other N driving lines, occur at the same time.

A control device for controlling electronic equipment is an embodiment of the present invention, too. The electronic equipment includes a screen that display an image, a plurality of driving lines arrayed in a first direction in an area that overlaps the screen, and a plurality of detection lines arrayed in a second direction in the area that overlaps the screen. The control device includes: a driving unit that outputs driving signals each of which includes a plurality of pulses, to the driving lines, respectively; and a detecting unit that detects signals of the detection lines in correspondence to the diving signals. The driving unit outputs driving signals each of which includes a plurality of pulses simultaneously to a group of 2N driving lines (N is a natural number) that are sequentially arrayed in the first direction. Rising of the pulses of the driving signals for the N driving lines of the group of the 2N driving lines, and falling of the pulses of the driving signals for the other N driving lines, occur at the same time.

The following description describes embodiments of the present invention in detail, while referring to the drawings. Identical or equivalent parts in the drawings are denoted by the same reference numerals, and the descriptions of the same are not repeated. To make the description easy to understand, in the drawings referred to hereinafter, the configurations are simply illustrated or schematically illustrated, or the illustration of part of constituent members is omitted. Further, the dimension ratios of the constituent members illustrated in the drawings do not necessarily indicate the real dimension ratios.

### Embodiment 1

### (Exemplary Configuration of Active Matrix Substrate)

### Embodiment 1

### (Exemplary Configuration of Sensor-Equipped Display Device)

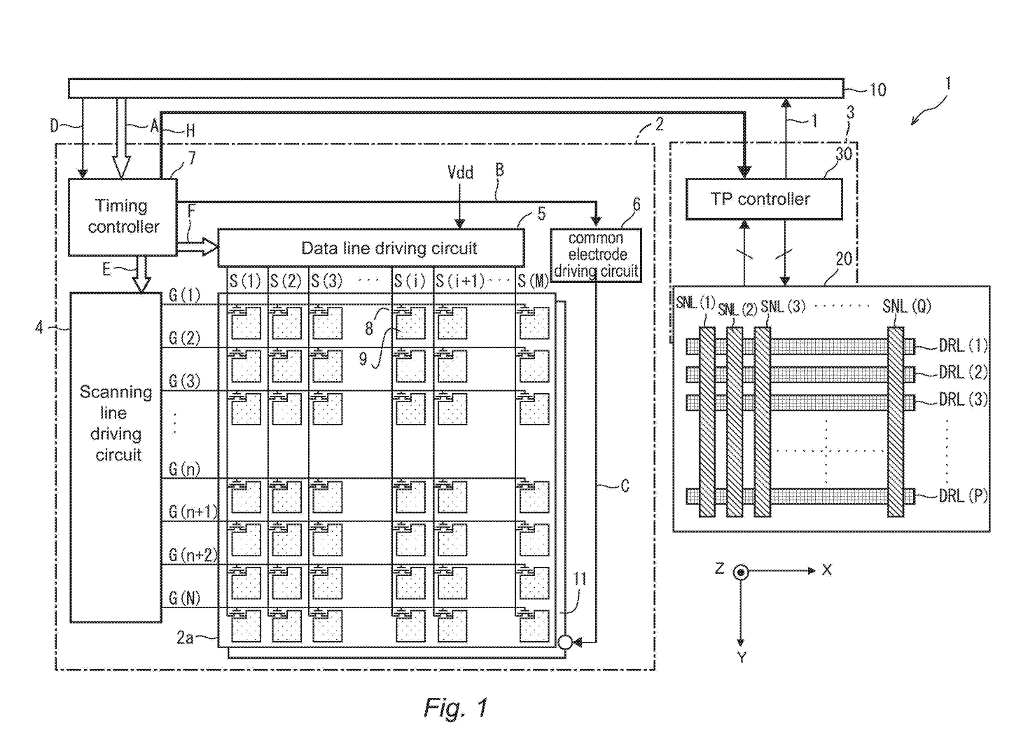

FIG. 1 is a block diagram illustrating an exemplary configuration of a sensor-equipped display device in Embodiment 1. The sensor-equipped display device 1 illustrated in FIG. 1 is electronic equipment that includes a screen that displays an image, and a sensor that detects contact or approach of an object with respect to the screen. The sensor-equipped display device 1 includes a display device 2, a detection device 3, and a system-side controller 10.

### <Exemplary Configuration of Display Device>

The display device 2 has a plurality of gate lines G (G(1), G(2), . . . . G(n), . . . . G(N)) and a plurality of data lines S (S(1), S(2), . . . , S(i), . . . S(M)), which are arranged in a display region 2a, which corresponds to the screen that displays an image. The gate lines G are exemplary display scanning lines, and are arrayed in a first direction (the Y direction in the example illustrated in FIG. 1). The data lines S are arrayed in a second direction that is different from the first direction (the X direction that intersects with the Y direction at right angles in the example illustrated in FIG. 1).

At positions corresponding to the points of intersection of the gate lines G and the data lines S, thin film transistors (TFTs) 8 are provided. Each TFT 8 is connected to the gate line G and the data line S. Further, to each TFT 8, a pixel electrode 9 is connected. The TFT 8 is an exemplary switching element. The TFT 8 is switched ON/OFF according to a signal of the gate line G. When the TFT 8 is ON, a signal of the data line S is input to the pixel electrode 9. This causes a voltage corresponding to a gray level to be displayed at the pixel is applied to the pixel electrode 9.

In the display region 2a, one pixel is arranged in an area surrounded by two adjacent gate lines G and two adjacent data lines S. In the display region 2a, a plurality of pixels are arranged in matrix. Each pixel includes the TFT 8 and the pixel electrode 9. The area where the pixels are arranged is the display region 2a, that is, the screen. Further, a common electrode 11 is provided at a position opposed to the plurality of pixel electrodes 9.

The display device 2 further includes a timing controller 7, a scanning line driving circuit (gate driver) 4, a data line driving circuit (source driver) 5, and a common electrode driving circuit 6. The timing controller 7 is connected to the system-side controller 10, the scanning line driving circuit 4, the data line driving circuit 5, and the common electrode driving circuit 6. The scanning line driving circuit 4 is connected to the gate lines G. The data line driving circuit 5 is connected to the data lines S. The common electrode driving circuit 6 is connected to the common electrode 11.

The timing controller 7 receives a video signal (as indicated by arrow A) and a synchronization signal (as indicated by arrow D) from the system-side controller 10. The timing controller 7 outputs a video signal to the data line driving circuit 5 (as indicated by arrow F). Based on a synchronization signal D, to the scanning line driving circuit 4, the data line driving circuit 5, and the common electrode driving circuit 6, the timing controller 7 outputs a signal that serves as a reference signal that these circuits refer to when the circuits operate in synchronization with one another, that is, a signal for controlling an operation timing (as indicated by arrows E, F, B).

The synchronization signal D includes, for example, a vertical synchronization signal and a horizontal synchronization signal. The vertical synchronization signal can be a signal that indicates the timing for scanning the screen, that is, the timing for updating the display on the screen. The horizontal synchronization signal can be a signal that indicates the timing for plotting the pixels in each row on the screen.

As one example, the timing controller 7 outputs a gate startpulse signal and a gate clock signal based on the vertical synchronization signal and the horizontal synchronization signal, to the scanning line driving circuit 4 (as indicated by arrow E). The gate startpulse signal can include, for example, a pulse that is generated at a timing corresponding to a timing at which a pulse of the vertical synchronization signal is generated. The gate clock signal can include a pulse that is generated at a timing corresponding to a timing at which a pulse of the horizontal synchronization signal is generated.

The timing controller 7 outputs a source startpulse signal, a source latch strobe signal, and a source clock signal based on the vertical synchronization signal and the horizontal synchronization signal, to the data line driving circuit 5 (as indicated by arrow F).

The scanning line driving circuit 4 supplies a signal indicating an image to be displayed, to each data line S. The scanning line driving circuit 4 repeats a scanning operation of selecting the gate lines G in one screen sequentially in the first direction (the Y direction), at cycles indicated by the vertical synchronization signal. More specifically, the scanning line driving circuit 4 starts an operation of scanning one screen according to the gate startpulse signal, and applies a selection signal to the gate lines G sequentially according to the gate clock signal.

The data line driving circuit 5 outputs a signal based on a video signal to the data lines S, in synchronization with the scanning of the gate lines G by the scanning line driving circuit 4. With this, a voltage according to an image to be displayed can be applied to the pixel electrode 9. More specifically, the data line driving circuit 5 sequentially holds, in a register, a digital video signal indicating a voltage to be applied to each data line, at a timing at which the pulse of the source clock signal is generated. The digital video signal thus held is converted into an analog voltage, at a timing at which the pulse of the source latch strobe signal is generated. The analog voltage thus obtained by conversion is applied to the plurality of data lines S at once, as a video signal for driving.

The common electrode driving circuit 6 applies a predetermined voltage to the common electrode 11, based on the signal received from the timing controller 7 (as indicated by arrow C).

As is described above, at a timing at which the selection signal is applied to each gate line, the video signal for diving is applied to the data line S, and further, a predetermined voltage is applied to the common electrode 11, whereby an image is displayed on the display region 2a, that is, on the screen.

### <Exemplary Configuration of Detection Device>

The detection device 3 is an exemplary sensor that detects contact or approach of an object such as a finger or a pen with respect to the screen of the display device 1. The detection device 3 includes a touch panel 20 and a touch panel controller (hereinafter referred to as a “TP controller”) 30.

The touch panel 20 includes a plurality of drive lines DRL (DRL(1) to DRL(P)) arrayed in the first direction (in the Y direction in the example illustrated in FIG. 1), and a plurality of detection lines SNL (SNL(1) to SNL(Q)) arrayed in the second direction (in the X direction intersecting with the Y direction at right angles in this example). The drive lines DRL are electrodes extending in the second direction (the X direction). The detection lines SNL are electrodes extending in the first direction (the Y direction). The first direction is a direction different from the second direction. In the present example, the first direction and the second direction are orthogonal to each other.

In FIG. 1, for the sake of explanation, the touch panel 20 and the display region 2a of the display device 2 are drawn at positions that do not overlap in the Z direction, but actually, the touch panel 20 is arranged at a position that overlaps the display region 2a of the display device 2 when viewed in the direction vertical to the screen. In other words, the drive lines DRL and the detection lines SNL are arranged so as to be superposed on the screen, which is the display region 2a. Further, the drive lines DRL are arranged so as to be arrayed in the same direction as the direction in which the gate lines G are arrayed (in the Y direction in the present example). The detection lines SNL are arranged so as to be arrayed in the same direction as the direction in which the data lines S are arrayed (in the X direction in the present example).

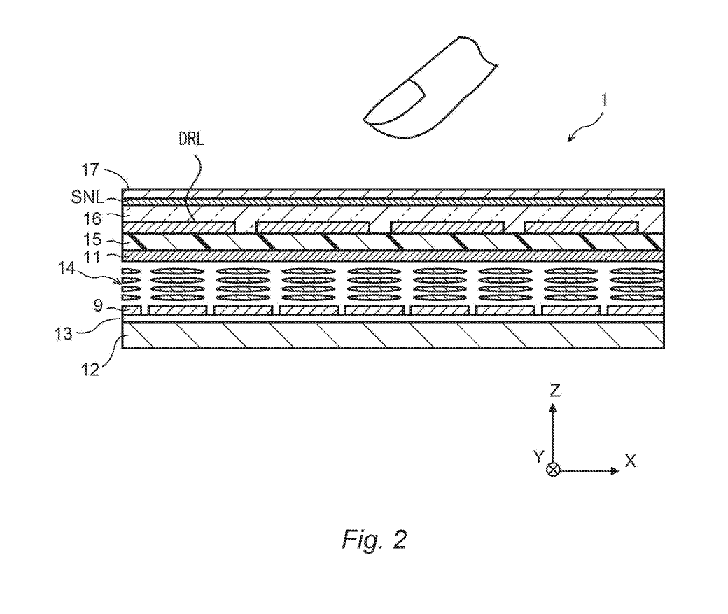

FIG. 2 is a cross-sectional view illustrating an exemplary configuration of the sensor-equipped display device 1 illustrated in FIG. 1. In the example illustrated in FIG. 2, the sensor-equipped display device 1 includes a first substrate 12 and a second substrate 16 that are opposed to each other. Between the first substrate 12 and the second substrate 16, a liquid crystal layer 14 is provided.

On a surface of the first substrate 12 opposed to the second substrate 16, the pixel electrodes 9 are provided. Further, the gate lines G, the data lines S, and the TFTs 8 are arranged on the first substrate 12, though these are not illustrated.

On a surface of the second substrate 16 opposed to the first substrate 12, a common electrode 11, a color filter 15, and the drive lines DRL are arranged. The common electrode 11 is opposed to the pixel electrodes 9, with the liquid crystal layer 14 being interposed therebetween. Further, the common electrode 11 is also opposed to the driving lines DRL, with the color filter 15 being interposed therebetween. In other words, the common electrode 11 is arranged in an area that overlaps the pixel electrodes 9 and the driving lines DRL, when viewed in a direction vertical to the first substrate 12. In the example illustrated in FIG. 2, the common electrode 11 is provided between the driving lines DRL and the pixel electrodes 9.

On another surface of the second substrate 16, namely, on a side opposite to the first substrate 12 side, the detection lines SNL and a polarizing plate 17 are arranged. This causes capacitances to occur between the driving lines DRL and the detection lines SNL. When an object such as a finger approaches the surface of the second substrate 16, the capacitances change. In other words, the capacitances at positions corresponding to the points of intersection between the driving lines DRL and the detection lines SNL change in response to contact or approach of an object. Changes in the capacitances are detected according to signals detected at the detection lines when driving signals are output to the driving lines DRL. With this, an object that is approaching or is in contact with the screen is detected. Incidentally, the driving lines DRL and the detection lines SNL may be formed in the same layer.

In the present example, the display device 2 and the detection device 3 are integrally formed with the first substrate 12 and the second substrate 16. Both of the drive lines DRL and the detection lines SNL are provided independently from the common electrode 11. In other words, the configuration is not such that the common electrode 11 of the display device 2 doubles as the drive lines DRL or the detection lines SNL of the touch panel 20. This makes the driving of the touch panel 20 less restricted by the driving of the display device 2.

The common electrode 11 may be provided on the first substrate. In this case, for example, the common electrode 11 can be provided at a position opposed to the plurality of the pixel electrodes 9, with an insulating layer 13 being interposed therebetween.

The first substrate 12 and the second substrate 16 can be formed with, for example, glass or resin. The pixel electrodes 9, the common electrode 11, the detection lines SNL, and the drive lines DRL can be formed with, for example, transparent electrodes such as electrodes made of indium tin oxide (ITO) or the like.

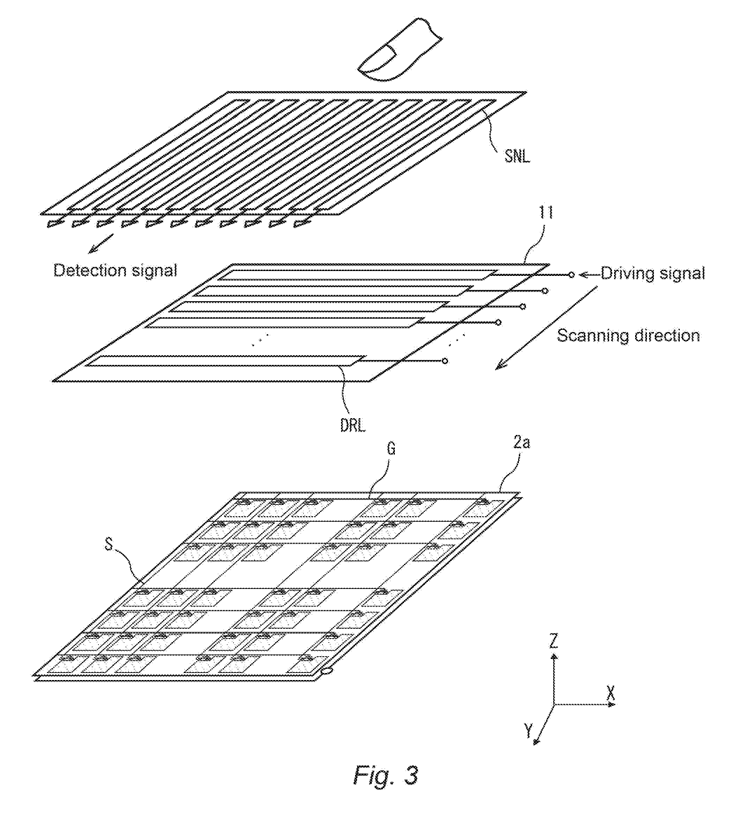

FIG. 3 is a perspective view illustrating an exemplary laminate structure of the drive lines DRL, the detection lines SNL, the gate lines G, and the data lines S. In the example illustrated in FIG. 3, the layer of the gate lines G, the layer of the data lines S, the layer of the common electrode 11, the layer of the drive lines DRL, and the layer of the detection lines SNL, are laminated in the Z direction. Capacitors are formed between the drive lines DRL and the detection lines SNL. The matrix formed by the drive lines DRL and the detection lines SNL is arranged so as to overlap the entirety of the display region 2a. This means that the drive lines DRL and the detection lines SNL are arranged in an area overlapping an area where the gate lines G and the data lines S are provided.

In the example illustrated in FIG. 3, the gate lines G and the drive lines DRL are arranged so as to be parallel to each other. The gate lines G and the drive lines DRL do not have to be completely parallel. For example, the direction of the gate lines G and the direction of the drive lines DRL may be slightly different. The drive lines DRL may include some parts that are not parallel with the gate lines G.

To the drive lines DRL, a driving signal is input sequentially. To the detection lines SNL, response signals in response to the driving signal are output as detection signals. The detection signals contain information with regard to capacitances at positions corresponding to the points of intersection between the drive lines DRL and the detection lines SNL.

For example, the TP controller 30 repeats a scanning operation of sequentially applying a driving signal to the drive lines DRL in the first direction (the Y direction), and in response to the driving of the drive lines DRL, detects respective detection signals of the detection lines SNL. The driving signal includes a plurality of pulses. During respective periods while the drive lines DRL are driven, the TP controller 30 detects respective signals of the detection lines SNL. In the detected signals, changes in the capacitances around the drive lines DRL and the detection lines SNL are reflected. In other words, changes in the capacitances in the display region 2a (the screen) are detected as the detection signals of the detection lines SNL. The TP controller 30 is capable of computing the position of contact or approach of an object with respect to the screen, based on the signals detected from the detection lines SNL. The TP controller 30 is an exemplary detection control unit.

The exemplary laminate structure of the gate lines G, the data lines S, the drive lines DRL, and the detection lines SNL is not limited to the example illustrated in FIGS. 2 and 3. For example, the order of lamination of the drive lines DRL and the detection lines SNL may be in the reverse order. Further, the substrate on which the drive lines DRL and the detection lines SNL are formed is not limited to the second substrate 16, but the drive lines DRL and the detection lines SNL can be arranged on the first substrate 12, or can be arranged dispersedly on both of the first substrate 12 and the second substrate 16.

FIG. 1 is referred to again. The TP controller 30 controls the timings of the screen scanning operation with respect to the drive lines DRL in the touch panel 20, based on a synchronization signal received from the timing controller 7. This allows the timings of the screen scanning operation with respect to the drive lines DRL to be controlled based on the timings of the screen scanning operation with respect to the gate lines G. Besides, this also allows the timings of the pulses of the driving signal to be output to the driving lines DRL to be controlled based on the timings of the signal output to the data lines S.

The TP controller 30 is capable of controlling the timings of the screen scanning operation with respect to the drive lines DRL so that, for example, the gate line G and the driving line DRL, driven simultaneously, should not overlap each other on the screen. In other words, while the screen scanning operation with respect to the gate lines G and the screen scanning operation with respect to the driving lines DRL are performed simultaneously, the timings of the screen scanning operation with respect to the drive lines DRL is controlled so that the area in which the gate line G is driven and the area in which the driving line DRL is driven should not overlap each other.

The TP controller 30 can, for example, advance/delay the start of the screen scanning operation with respect to the driving lines DRL, from the start of the screen scanning operation with respect to the gate lines G. Besides, the TP controller 30 can appropriately set time for scanning one screen with respect to the drive lines DRL, thereby making it possible to ensure that the position at which the gate line G is scanned and the position at which the driving line DRL is scanned should not overlap each other.

For example, the TP controller 30 can cause the screen scanning operation with respect to the gate lines G to be started between the start and the end of the time for scanning one screen with respect to the driving lines DRL, and can control the time for scanning one screen with respect to the drive lines DRL so that it should be equal to or shorter than the time for scanning one screen with respect to the gate lines G.

Here, “time for scanning one screen” is time necessary for performing a single screen scanning operation. For example, a time required for scanning all of the drive lines DRL or the gate lines G to be scanned in a single screen scanning operation is assumed to be “time for scanning one screen”. On the other hand, a cycle of the screen scanning operation is a period of time from the start of a current one of the screen scanning operation until the start of a next one of the screen scanning operation. The time for scanning one screen, therefore, is not necessarily equal to the cycle of the screen scanning operation.

The TP controller 30 can generate a signal for controlling timings for driving the drive lines DRL, based on a synchronization signal for controlling timings for scanning the gate lines G. For example, based on the timings at which the pulses of the vertical synchronization signal received from the timing controller 7 are generated, the TP controller 30 can generate a signal indicating a timing for starting the screen scanning operation with respect to the drive lines DRL.

As one example, the TP controller 30 can generate a trigger signal that causes a pulse to be generated at a point in time that is advanced/delayed for a certain period of time from the point in time when the pulse of the vertical synchronization signal is generated. The TP controller 30 causes the screen scanning operation with respect to the drive lines DRL at a timing when the pulse of the trigger signal is generated. This allows the screen scanning operation with respect to the drive lines DRL to start at a point in time that is advanced/delayed for a certain period of time from the point in time when the screen scanning operation with respect to the gate lines starts. Or alternatively, in response to the generation of a pulse of the trigger signal, a startpulse signal that causes a pulse to be generated at a predetermined cycle may be generated, so that this is used as a signal that instructs the start of the screen scanning operation with respect to the drive lines DRL. By controlling the start of the screen scanning operation with respect to the drive lines DRL in this way by using the trigger signal that indicates the timing advanced/delayed from the pulse of the vertical synchronization signal, the screen scanning operation with respect to the drive lines DRL can start before the screen scanning operation with respect to the gate lines starts.

A driving signal applied to one drive line DRL can include, for example, a plurality of pulses generated at a predetermined frequency. By controlling the number of such pulses and frequencies thereof, the time for scanning the drive lines DRL in one screen can be controlled. The TP controller 30 can set the number of pulses of the driving signal and the frequency thereof, by using, for example, a value preliminarily recorded in a register (not shown) or the like. Or alternatively, the TP controller 30 can control the frequency of the pulses of the diving signal, by using the synchronization signal used for driving the display device 1.

For example, the TP controller 30 can control the timings of the pulses to be applied to each drive line DRL, based on the horizontal synchronization signal received from the timing controller 7. As a specific example, a signal that has pulses that are generated at the same cycle as the cycle at which the pulses of the horizontal synchronization signal are generated, and that is generated at timings advanced/delayed for a certain period of time from the timings at which the pulses of the horizontal synchronization signal are generated, can be used as a driving signal for each drive line DRL. This makes it possible to drive the drive lines DRL at timings advanced/delayed from the timings of the signal output to the data lines S. In other words, at a timing that does not interfere with the signal output to the data lines S, the detection scanning lines can be driven.

Further, the TP controller 30 can output, to the driving lines DRL, a driving signal having pulses that are generated at a frequency that is different from the frequency of the horizontal synchronization signal. The frequency of the pulses can be determined by using, for example, a value that is preliminarily recoded in a register or the like. TP controller 30 may have such a configuration that a plurality of frequencies are recorded preliminarily, and an appropriate frequency is selected according to the noise level.

The TP controller 30 outputs driving signals each of which has a plurality of pulses, to 2N driving lines DRL arrayed serially in the first direction (N is a natural number) simultaneously. In other words, 2N driving lines DRL that are adjacent are grouped into one set (group). The driving signals are simultaneously output to the group of 2N driving lines DRL. The TP controller 30 controls the driving signals to be output to the group of these 2N driving lines DRL. The controller 30 controls the driving signals in such a manner that the rising of consecutive pulses for N driving lines DRL of the 2N driving lines DRL, and the falling of consecutive pulses for the other N driving lines DRL of the 2N driving lines DRL, which are other than the above-described N driving lines DRL, occur at the same timing.

This causes the timing at which the signal level rises in N of the 2N driving lines DRL, and the timing at which the signal level falls in the other N driving lines DRL to approximately coincide with each other. This allows the noise caused by the driving signals for the N driving lines DRL and the noise caused by the driving signals for the other N driving lines DRL to cancel each other. As a result, noise occurring in the area where the group of the 2N driving lines DRL is located is reduced.

From the viewpoint of reducing noise, it is preferable to control the driving signals in such a manner that the falling of pulses for the N driving lines DRL of the 2N driving lines DRL, and the rising of the pulses for the other N of the 2N driving lines DRL occur at the same timing.

It should be noted that the aspect in which the rising of the pulses in the N driving lines DRL, and the falling of the pulses in the other N driving lines DRL occur at the same timing encompasses a case where the instant of rising and the instant of falling are so close that noise can be reduced, even with a slight deviation therebetween.

The TP controller 30 outputs driving signals having pulses that occur at the same timing, to 2N driving lines DRL, simultaneously. Here, the polarity of the pulses of the driving signals for the N driving lines of the 2N driving lines, and the polarity of the pulses of the driving signals for the other N driving lines, can be set opposite to each other. In other words, the control can be in the following manner: the pulses of the driving signals for the 2N driving lines occur at the same timing, and the polarity of the pulses of the driving signals for the N driving lines of the 2N driving lines and the polarity of the pulses of the driving signals for the other N driving lines are opposite to each other.

Alternatively, the TP controller 30 can output driving signals having a plurality of pulses to N of the 2N driving lines DRL, and output, to the other N driving lines DRL, driving signals having pulses that are obtained by reversing the above-described pulses for the N driving lines DRL.

### <Exemplary Operation of Detection Device>

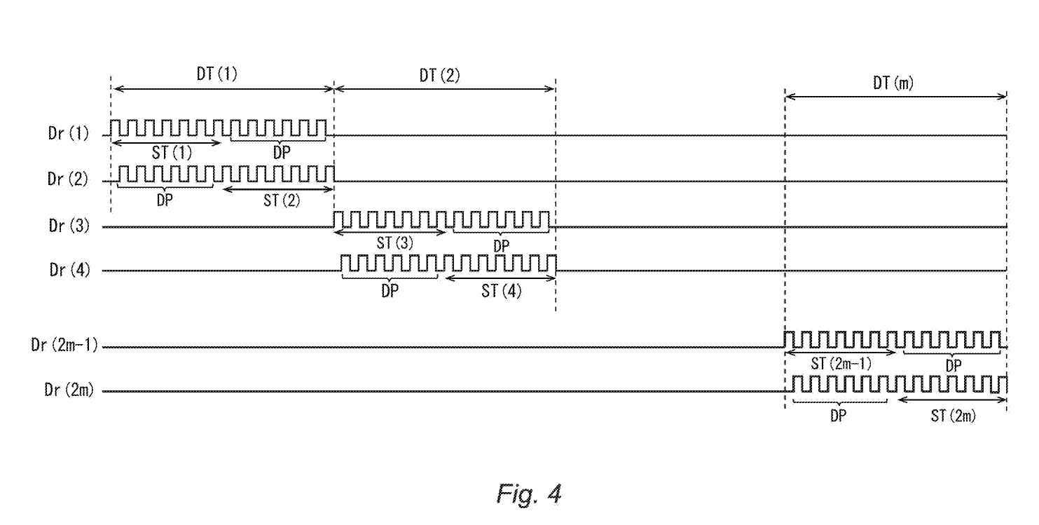

FIG. 4 illustrates exemplary waveforms of the driving signals in the detection device 3. In the example illustrated in FIG. 4, two driving lines DRL adjacent to each other are assumed to be one group. The controller 30 outputs driving signals simultaneously to the group of the two adjacent driving lines DRL. In other words, FIG. 4 illustrates an example in a case where N=1. The driving lines DRL(1) to DRL(P) include a plurality of groups (m groups) each of which is composed of two driving lines DRL to which the driving signals are input simultaneously. Here, m is a natural number.

More specifically, first, the driving signals Dr(1) and Dr(2) are input simultaneously to the driving line DRL(1) and the driving line DRL(2) of the first group, respectively. The TP controller 30 controls the driving signals in such a manner that the rising of the pulses the driving signal Dr(1) and the falling of the pulses of the driving signal Dr(2) occur at the same time. Further, as illustrated in FIG. 4, the falling of the pulses of the driving signal Dr(1) and the rising of the pulses of the driving signal Dr(2) are controlled so as to occur at the same time. In other words, pulses having the same timings and different polarities are output to the driving line DRL(1) and the driving line DRL(2), respectively.

The driving signals Dr(1) and Dr(2) for the driving lines DRL(1) and DRL(2) of the first group are output for a certain duration of time DT(1). In other words, a preliminarily set number of pulses are output to the driving lines DRL(1) and (2) at a certain cycle. After the driving of the first group ends, the driving signals Dr(3) and Dr(4) are output to the next group, that is, the driving lines DRL(3) and DRL(4) of the second group, for a certain duration of time DT(2). In this way, the driving signals of a certain duration each are output sequentially to a plurality of groups (the first to m-th groups) of the driving lines DRL. The output durations DT(1), DT(2), . . . DT(3) of the driving signals to all of the groups of the driving lines DRL, respectively, can be set equal to one another.

The TP controller 30 detects changes in capacitances in the areas of the driving lines DRL(1) and DRL(2) based on the signals detected at the detection lines SNL when the driving signals Dr(1) and Dr(2) are output to the two driving lines DRL(1) and DRL(2), respectively. Here, the capacitances at positions corresponding to the points of intersection between the driving line DRL(1) and the detection lines SNL(1) to SNL(Q), and the capacitances at positions corresponding to the points of intersection between the driving line DRL(2) and the detection lines SNL(1) to SNL(Q) are detected.

Likewise, based on the signals detected when the driving signals Dr(3) and Dr(4) are output, capacitances at positions corresponding to the points of intersection between the driving line DRL(3) and the detection lines SNL, and capacitances at position corresponding to the points of intersection between the driving line DRL(4) and the detection lines SNL, are detected. In this way, according to the signals detected in correspondence to the driving signals Dr sequentially output to the m groups of the driving lines DRL, capacitances at positions corresponding to the points of intersection between the two driving lines DRL of each group and the detection lines SNL(1) to SNL(Q) are sequentially detected.

The present example is an example in which N=1, but in cases where N is 2 or more, too, the TP controller 30 can detect capacitances at positions corresponding to the points of intersection between the 2N driving lines DRL and the detection line SNL, according to signals detected at the detection lines SNL upon the output of the driving signals Dr to the group of the 2N driving lines DRL.

For example, the duration while the driving signals are output to the 2N driving lines DRL is divided into 2N durations, and in each of the division durations, a capacitance of one of the driving lines DRL can be detected. In the example illustrated in FIG. 4, a duration DT(1) while the driving signals Dr(1) and Dr(2) are output to the driving lines DRL(1) and DRL(2) of the first group is divided into two sections of time ST(1) and ST(2).

According to signals detected at the detection line SNL during one section ST(1) of the two sections of time thus obtained by division, capacitances corresponding to the points of intersection between the driving line DRL(1) and the detection lines SNL(1) to SNL(Q) are detected. In the section ST(1), for example, according to signals detected at timings corresponding to the pulses of the driving signal Dr(1), capacitances at positions corresponding to the driving line DRL(1) can be detected. Here, the pulses of the driving signal Dr(2) serve as dummy pulses DP.

During the other section ST(2) of the two sections of time thus obtained by division, the TP controller 30 can detects capacitances at positions corresponding to the driving line DRL(2), according to signals detected at timings corresponding to the pulses of the driving signal Dr(2). In the section ST(2), the pulses of the driving signal Dr(1) serve as dummy pulse DP.

In this way, capacitances corresponding to the driving line DRL(1) are detected during the section ST(1), and capacitances corresponding to the driving line DRL(2) are detected during the section ST(2). The TP controller 30, therefore, can make the timings for detecting the signals of the detection lines SNL during the section ST(1), and the timings for detecting the signals of the detection lines SNL during the section ST(2), different from each other. For example, during the section ST(1), the TP controller 30 detects signals of the detection lines SNL when the driving signal Dr(1) is at a high level, and during the section ST(2), detects signals of the detection lines SNL when the driving signal Dr(2) is at a high level.

Or, alternatively, the TP controller 30 can make the computation of capacitance values based on the signals detected during the section ST(1), and the computation of capacitance values based on the signals detected during the section ST(2), different from each other. For example, capacitance values can be computed by comparing the signals detected from the detection lines SNL and a reference signal, and using the differences therebetween. In this case, different reference signals can be used during the sections ST(1) and ST(2), respectively.

It should be noted that the computation of respective capacitances corresponding to the driving lines DRL is not limited to the above-described example. For example, the TP controller 30 can compute capacitances at the 2N driving lines DRL in the following manner: with the driving signals for the 2N driving lines DRL, at least 2N pulses are output; signals are detected from the detection lines SNL at at least 2N times in correspondence to the pulses; and a matrix operation or the like is executed using the signals thus detected.

Here, “i” and “j” are assumed to satisfy i=1, 2, . . . . P and j=1, 2, . . . , Q, and a capacitance corresponding to a point of intersection between the driving line DRL(i) and the detection line SNL(j) is given as Cij. In a case where driving signals Dr(i) to Dr(i+2N) are output to 2N driving lines DRL(i) to DRL(i+2N), a signal value corresponding to a value obtained by adding or subtracting respective capacitances Cij, C(i+1)j, . . . C(i+2N)j at points of intersection between the driving lines DRL(i) to DRL(i+2N) and a detection line SNL(j) is detected from the detection line SNL(j). When the 2N driving lines DRL(i) to DRL(i+2N) are driven, the combination of polarities of pulses output to the N driving lines DRL and the other N driving lines DRL simultaneously can be varied in 2N ways, and 2N signal detection values can be acquired from the detection line SNL regarding each combination. By computation using these 2N detection values, capacitances Cij, C(i+1)j, . . . C(i+2N)j can be calculated.

For example, when a pulse of a positive (+) polarity is output to the driving line DRL(1) and a pulse of a negative (−) polarity is output to the driving line DRL(2) simultaneously, a voltage value Vout1 detected from the detection line SNL(1) is Vout1=(C11-C21)·V/Cint. Here, V/Cint can be set to be constant. In a case where a negative pulse is output to the driving line DRL(1) and a positive pulse is output to the driving line DRL(2), a voltage value Vout2 detected from the detection line SNL(1) satisfies Vout2=(−C11+C21)·V/Cint. With Vout1 and Vout2, values of Cout1 and Cout2 are computed as satisfying Cout1=C11-C21 and Cout2=−C11+C21. With use of these values, an operation of solving simultaneous equations in which C11 and C12 are variables is performed, whereby values of C11 and C12 can be computed.

Further, for example, driving signals Dr that are an orthogonal system are output to the 2N driving lines DRL, and signals of the detection lines SNL obtained in response to the driving signals Dr are subjected to a matrix arithmetic operation such as inner multiplication, whereby capacitance distribution in the 2N driving lines DRL can be computed. The method for computing the capacitances, however, is not limited to the above-described example.

In this way, by outputting the driving signals Dr sequentially to the driving lines DRL of the 1 to m groups, the screen scanning operation with respect to the driving lines DRL is performed. By the screen scanning operation with respect to the driving lines DRL, contact or approach of an object such as a finger or a pen to the screen can be detected.

Here, the controlling operation is performed in such a manner that, regarding the driving signals Dr simultaneously output to the 2N driving lines DRL of each group, the rising of pulses of the driving signals (for example, Dr(1)) for the N driving lines (for example, DRL(1) in FIG. 4), and the falling of the pulses of the driving signals (for example, Dr(2)) for the other N driving lines DRL (for example, DRL(2)), occur at the same time. Further, the controlling operation is performed in such a manner that the falling of pulses of the driving signals (Dr(1)) for the N driving lines (DRL(1)), and the rising of the pulses of the driving signals (Dr(2)) for the other N driving lines (DRL(2)), occur at the same time.

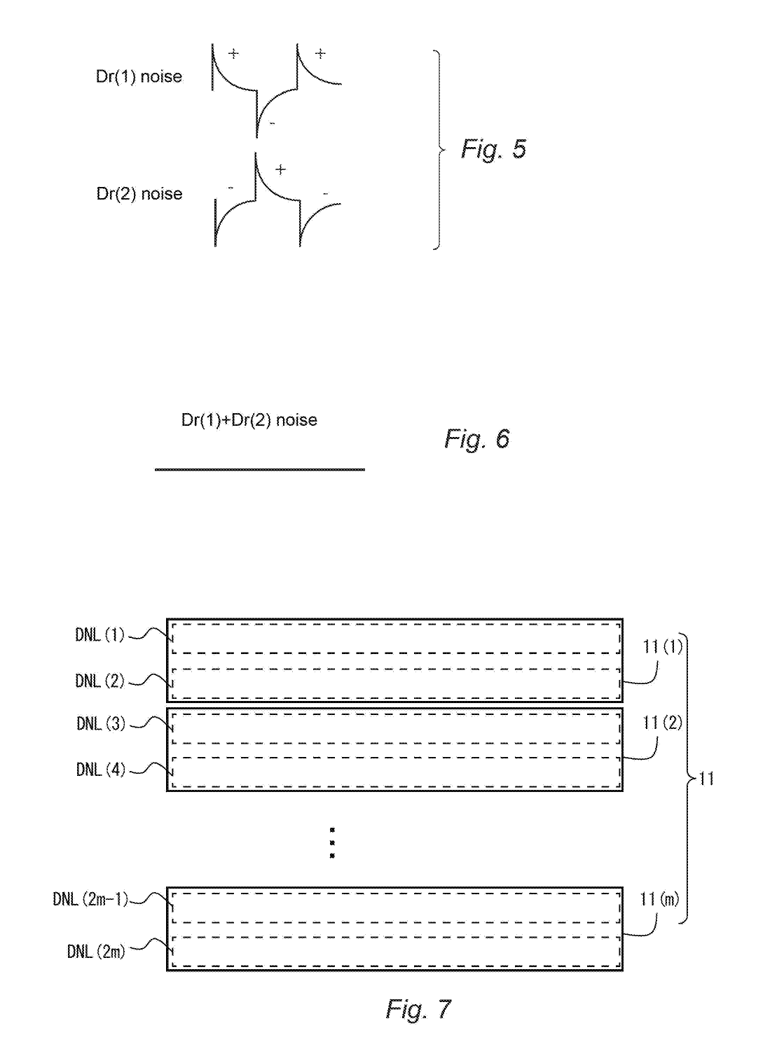

FIG. 5 illustrates exemplary noises generated by the driving signals Dr(1) and Dr(2) for the driving lines DRL(1) and DRL(2) illustrated in FIG. 4. FIG. 5 illustrates fluctuations of the levels of the respective noises generated by the driving signals Dr(1) and Dr(2). At the timing when the pulse of the driving signal Dr(1) rises, the noise fluctuates in the positive direction, and at the timing when the pulse falls, the noise fluctuates in the negative direction. The noise generated by the driving signal Dr(2) exhibits similar fluctuations. If the noise generated by the driving signal Dr(1) and the noise generated by the driving signal Dr(2) are superimposed on each other, a noise waveform having small fluctuations as illustrated in FIG. 6 is obtained. For example, the potential level of the common electrode 11 tends to fluctuate according to the levels of the noises of the driving lines DRL. For this reason, by reducing the fluctuations of the noise as illustrated in FIG. 6, fluctuations of the potential level of the common electrode 11 can be made smaller.

According to the present embodiment, the rising of the pulses of the driving signals for the N driving lines DRL and the falling of the pulses of the driving signals for the other N driving lines DRL occur at the same timing, whereby the potential level of the common electrode 11 can be prevented from fluctuating. As a result, fluctuations of voltages applied to the liquid crystal layer in pixel writing become smaller. Further, display noises hardly occur.

In the above-described example, regarding all of the pulses of the driving signal Dr(1) and all of the pulses of the driving signal Dr(2), the rising and the falling occur at the same time. In cases where, however, rising and falling timings of a part of the pulses of the driving signal Dr(1) and a part of the pulses of the driving signal Dr(2) are made to coincide, too, the noise reducing effect can be achieved. For example, regarding the driving signal for the N driving lines out of the 2N driving lines, and the driving signal for the other N driving lines, the ratio of the number of pulses thereof that are caused to occur at the same time may be controlled, whereby the degree of the noise reducing effect can be adjusted.

### Modification Example of Common Electrode 11

FIG. 7 illustrates a modification example of the common electrode 11. In the example illustrated in FIG. 7, the common electrode 11 includes a plurality of electrode portions 11(1) to 11(m) corresponding to a plurality of groups (i.e., 1st to m-th groups) each of which is composed of two driving lines DRL, respectively.

The electrode portions 11(1) to 11(m) are arranged at positions opposed to the 1st to m-th groups of the driving lines DRL, respectively. In other words, the electrode portions 11(1) to 11(m) are arranged in areas that overlap the first to m-th groups of the driving lines DRL, respectively, when viewed in a direction vertical to the screen. Each of the electrode portions 11(1) to 11(m) is opposed to two adjacent driving lines DRL. The electrode portions 11(1) to 11 (m) are arranged so as to be separated from one another.

In the present example, the electrode portions 11(1) to 11(m) are electrically disconnected from one another. Lines are connected to the electrode portions 11(1) to 11(m). Through these respective lines, the electrode portions 11(1) to 11(m) and the common electrode driving circuit 6 (see FIG. 1) are connected.

The electrode portions 11(1) to 11(m) are arranged so as to be arrayed in the same direction as the first direction in which the driving lines DRL(1) to DRL(2m) are arrayed. Further, the electrode portions 11(1) to 11(m) are formed so as to extend in the same direction as that in which the driving lines DRL(1) to DRL(2m) extend (the second direction).

For example, the electrode portion 11(1) opposed to the two driving lines DRL(1) and DRL(2) of the first group is arranged so as to be separated from the portions opposed to the other driving lines DRL(3) to DRL(2m). In the present example, the electrode portion 11(1), and the electrode portion 11(2) adjacent to the electrode portion 11(1), are not electrically connected, and are arranged so as to be separated from each other.

In this way, the common electrode 11 can be patterned so that the electrode portions 11(1) to 11(m) corresponding to the 2N driving lines DRL are formed. By dividing the common electrode 11 into a plurality of the electrode portions in this way, the reduction of the resistance of the common electrode 11 can be achieved. Further, fluctuations of the potential level of the common electrode 11, caused by the noise of the driving signals Dr or the like can be stabilized quickly. As a result, the pixel writing operation for display is stabilized.

Incidentally, in the example illustrated in FIG. 7, the electrode portions 11(1) to 11(m), each of which is opposed to the 2N driving lines DRL of one group to which the driving signals are output simultaneously, are provided. In contrast, the common electrode 11 may include electrode portions each of which is opposed to a plurality of groups each of which is composed of 2N driving lines DRL. For example, an electrode portion opposed to the driving lines DRL(1) to DRL(4) belonging to the first and second groups may be provided in the common electrode 11. Further, a plurality of the electrode portions 11(1) to 11(m) in the common electrode 11 are not necessarily disconnected electrically.

### Modification Example 1 of Driving Signal

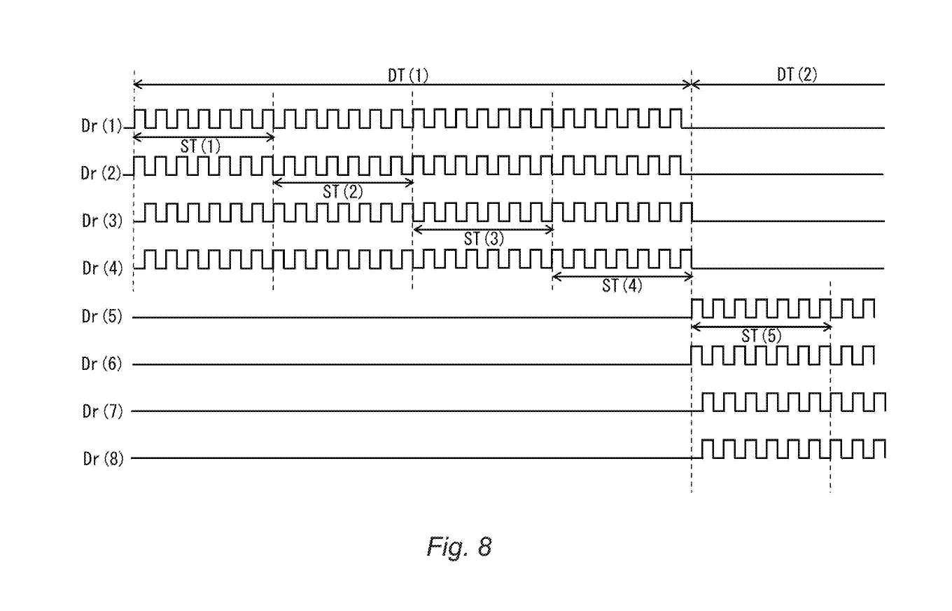

FIG. 8 illustrates a modification example of the driving signals. The example illustrated in FIG. 8 is an example in a case in which N=2. In other words, the controller 30 outputs driving signals simultaneously to four driving lines DRL. Regarding the four driving lines DRL(1) to DRL(4), the rising of pulses of the driving signals Dr(1) and Dr(2) for the two driving lines DRL(1) and DRL(2), and the falling of pulses of the driving signals Dr(3) and Dr(4) for the other two driving lines DRL(3) and DRL(4), occur at the same time.

In the example illustrated in FIG. 8, pulses of the same phase are output to two adjacent ones of the driving lines DRL. More specifically, the pulses of the driving signals Dr(1) and Dr(2) for the two adjacent driving lines DRL(1) and DRL(2), out of the four adjacent driving lines DRL, rise and fall at the same time, and the pulses of the driving signals Dr(1) and Dr(2) for the other two driving lines DRL(1) and DRL(2) rise and fall at the same time.

In contrast, as a further modification example, the TP controller 30 may be capable of outputting pulses having opposite phases, as driving signals Dr for two adjacent driving lines DRL. More specifically, the configuration may be as follows: in two adjacent driving lines DRL(1) and DRL(2) out of four driving lines DRL, the rising of the pulses of the driving signal Dr(1), and the falling of the pulses of the driving signal Dr(2), are caused to occur at the same time. In other words, the rising of the pulses of the odd-number-th driving lines DRL, and the falling of the pulses of the even-number-th driving lines DRL, can be caused to occur at the same time.

According to signals detected from the detection lines SNL during a duration of time DT(1) while the driving signals Dr(1) to Dr(4) are output to the four driving lines DRL(1) to (4), capacitances corresponding to the respective points of intersection between these four driving lines DRL(1) to DRL(4) and the detection lines SNL are detected.

For example, according to signals detected during four sections of time ST(1) to ST(4) included in a duration of time DT(1) while the driving signals Dr(1) to Dr(4) for the four driving lines DRL(1) to DRL(4) are output, capacitances corresponding to respective positions of the four driving lines DRL(1) to DRL(4) are detected. More specifically, according to signals detected in correspondence to the driving signal Dr(1) during the section ST(1), capacitances corresponding to respective points of intersection between the driving line DRL(1) and the detection lines SNL(1) to (Q) are detected. Likewise, during the sections ST(2) to ST(4), capacitances corresponding to the respective positions of the driving lines DRL(2) to DRL(4) are detected.

Alternatively, the TP controller 30 can calculate capacitances corresponding to respective positions of the driving lines DRL(1) to DRL(4), based on signals detected at least four times during the duration DT(1).

### Modification Example 2 of Driving Signal

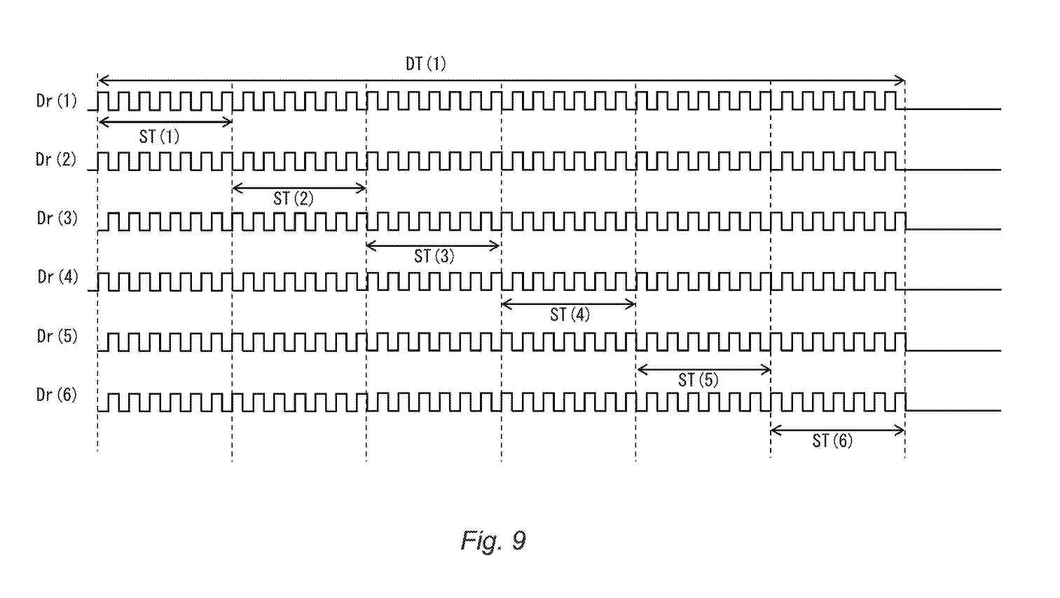

FIG. 9 illustrates another modification example of driving signals. The example illustrated in FIG. 9 is an example in a case in which N=3. In other words, the controller 30 outputs driving signals simultaneously to six driving lines DRL. Regarding six driving lines DRL(1) to DRL(6), the rising of pulses of the driving signals Dr(1), Dr(2) and Dr(4) for the three driving lines DRL(1). DRL(2) and DRL(4), and the falling of pulses of the driving signals Dr(3), Dr(5) and Dr(6) for the other three driving lines DRL(3), DRL(5) and DRL(6), occur at the same time.

In the example illustrated in FIG. 9, pulses of the same phase are output to three driving lines DRL(1), DRL(2), and DRL(4) out of the six driving lines DRL(1) to (6), and pulses of the phase opposite to the phase of the foregoing pulses are output to the other three driving lines DRL(3), DRL(5), and DRL(6). It should be noted that the combinations of the driving lines to which pulses of the same phase are output are not limited to the above-described combinations. For example, pulses of the same phase may be output to the driving lines DRL(1) to DRL(3).

In the case illustrated in FIG. 9, too, during six sections of time ST(1) to ST(6) included in a duration of time DT(1) while the driving signals Dr(1) to Dr(6) are output to the six driving lines DRL(1) to DRL(6), respectively, capacitances corresponding to the respective positions of the driving lines DRL(1) to DRL(6) can be detected. Alternatively, the TP controller 30 can calculate capacitances corresponding to the respective positions of the driving lines DRL(1) to DRL(6), based on signals detected at least six times in the duration DT(1).

The embodiments of the present invention are described above, but the present invention is not limited to the above-described embodiments.

The relationship between the directions in which the driving lines DRL and the detection lines SNL are arrayed, and the directions in which the gate lines G and the data lines S are arrayed, is not limited to that in the above-described examples. For example, the data lines S may be arrayed in the first direction (the Y direction), and the gate lines G may be arrayed in the second direction (the X direction).

The embodiments described above are described with reference to exemplary driving signals in a case where N=1, a case where N=2, and a case where N=3, but the value of “N” is not limited to these; the driving operation in a case where N is set to 4 or more is possible.

The above-described embodiments are examples of a mutual capacitance touch panel, but the touch panel may be a self-capacitance touch panel.

The sensor-equipped display device 1 in the above-described embodiments has such a configuration that the display device 2 and the detection device 3 are integrally formed by using the first substrate 12 and the second substrate 16. In other words, the sensor-equipped display device 1 is a touch panel built-in type display device. In contrast, the sensor-equipped display device may have such a configuration that a display device and a detection device formed on different substrates, respectively, are stacked on each other. In this case, the configuration is such that the substrate of the display device 2 and the substrate of the detection device 3 are different.

Further, the display device 2 is not limited to the liquid crystal display device as described above. The display device 2 may be, for example, an organic EL display, a plasma display, or a display in which electrophoresis or MEMS is used.

### DESCRIPTION OF REFERENCE NUMERALS

1: sensor-equipped display device
2: display device
3: detection device
4: scanning line driving circuit (exemplary scanning driving unit)
5: data line driving circuit (exemplary data driving unit)
8: TFT (exemplary switching element)
9: pixel electrode
11: common electrode
20: touch panel
30: TP controller (exemplary detection control unit)
G: gate line (exemplary display scanning line)
S: data line
DRL: drive line (exemplary detection scanning line)
SNL: detection line

1. A sensor-equipped display device comprising a screen that display an image, and a sensor that detects contact or approach of an object with respect to the screen, the sensor-equipped display device comprising:
a plurality of driving lines arrayed in a first direction in an area that overlaps the screen;
a plurality of detection lines arrayed in a second direction in the area that overlaps the screen; and
a detection control unit that outputs driving signals each of which includes a plurality of pulses, to the driving lines, respectively, and detects signals of the detection lines in correspondence to the diving signals,
wherein the detection control unit outputs driving signals each of which includes a plurality of pulses, simultaneously to a group of 2N driving lines (N is a natural number) out of the driving lines, the 2N driving lines being sequentially arrayed in the first direction, and
rising of the pulses of the driving signals for the N driving lines of the group of the 2N driving lines, and falling of the pulses of the driving signals for the other N driving lines, occur at the same time.

2. The sensor-equipped display device according to claim 1, further comprising:
scanning lines arrayed in one of the first direction and the second direction in the area that overlaps the screen;
data lines arrayed in the other one of the first direction and the second direction in the area that overlaps the screen;
a plurality of switching elements provided in correspondence to points of intersection between the scanning lines and the data lines, respectively;
a plurality of pixel electrodes connected to the switching elements, respectively; and
a common electrode opposed to the pixel electrodes and the driving lines,
wherein a portion of the common electrode opposed to the group of the 2N driving lines is arranged so as to be separated from a portion thereof opposed to the other driving lines.

3. The sensor-equipped display device according to claim 1,
wherein the driving lines include a plurality of groups each of which includes 2N driving lines to which the driving signals are output simultaneously, and
the diving signals are output sequentially to the groups each of which includes 2N driving lines.

4. The sensor-equipped display device according to claim 2,
wherein the common electrode includes a plurality of electrode portions that are respectively opposed to the groups each of which includes 2N driving lines, and
the electrode portions are arranged so as to be separated from one another.

5. The sensor-equipped display device according to claim 1, further comprising:
a first substrate on which the scanning lines, the data lines, the switching elements, and the pixel electrodes are arranged; and
a second substrate provided so as to be opposed to the first substrate,
wherein the driving lines and the detection lines are arranged on at least one of the first substrate and the second substrate.

6. The sensor-equipped display device according to claim 1, further comprising:
scanning lines arrayed in one of the first direction and the second direction in the area that overlaps the screen;
data lines arrayed in the other one of the first direction and the second direction in the area that overlaps the screen;
a plurality of switching elements provided in correspondence to points of intersection between the scanning lines and the data lines, respectively;
a plurality of pixel electrodes connected to the switching elements, respectively;
a scanning driving unit that repeats a screen scanning operation with respect to the scanning lines, the screen scanning operation with respect to the scanning lines being an operation of selecting the scanning lines sequentially in the first direction throughout the screen; and
a data driving unit that outputs a signal to the data lines in synchronization with the scanning of the scanning lines by the scanning driving unit, thereby applying, to the pixel electrodes, voltages corresponding to gray levels to be displayed, respectively;
wherein the detection control unit performs the screen scanning operation with respect to the driving lines, during at least a part of time while the screen scanning operation with respect to the scanning lines is performed.

7. A method for controlling electronic equipment that includes a screen that display an image, a plurality of driving lines arrayed in a first direction in an area that overlaps the screen, and a plurality of detection lines arrayed in a second direction in the area that overlaps the screen, the method comprising:
a driving step of outputting driving signals each of which includes a plurality of pulses, to the driving lines, respectively; and
a detecting step of detecting signals of the detection lines in correspondence to the diving signals,
wherein in the driving step, driving signals each of which includes a plurality of pulses are output simultaneously to a group of 2N driving lines (N is a natural number) that are sequentially arrayed in the first direction, and
rising of the pulses of the driving signals for the N driving lines of the group of the 2N driving lines, and falling of the pulses of the driving signals for the other N driving lines, occur at the same time.

8. A control device for controlling electronic equipment that includes a screen that display an image, a plurality of driving lines arrayed in a first direction in an area that overlaps the screen, and a plurality of detection lines arrayed in a second direction in the area that overlaps the screen, the control device comprising:
a driving unit that outputs driving signals each of which includes a plurality of pulses, to the driving lines, respectively; and
a detecting unit that detects signals of the detection lines in correspondence to the diving signals,
wherein the driving unit outputs driving signals each of which includes a plurality of pulses simultaneously to a group of 2N driving lines (N is a natural number) that are sequentially arrayed in the first direction, and
rising of the pulses of the driving signals for the N driving lines of the group of the 2N driving lines, and falling of the pulses of the driving signals for the other N driving lines, occur at the same time.
